(19) United States
(12) Patent Application Publication
(10) Pub. No.: US 2010/0142507 A1
(43) Pub. Date: Jun. 10, 2010

(54) DYNAMIC MULTI-PATH DETECTING METHOD AND DEVICE IN CDMA COMMUNICATION SYSTEM

(76) Inventors: Chao Li, Beijing (CN); Jiyang Li, Beijing (CN); Chaolun Xu, Beijing (CN)

Correspondence Address: JOHN ALEXANDER GALBREATH, 2516 CHESTNUT WOODS CT, REISTERSTOWN, MD, 21136, US

(21) Appl. No.: 12/599,506

(22) PCT Filed: Apr. 27, 2007
(86) PCT No.: PCT/CN07/01422

§ 371 Date: Dec. 29, 2009

(30) Foreign Application Priority Data
Apr. 9, 2007 (CN) 200710090837.X

(51) Int. Cl. H04B 7/216

(52) U.S. Cl. 370/342

(57) ABSTRACT

A dynamic multi-path detecting method in CDMA communication system is disclosed, the method includes: A, perform dynamic multi-path difference detection for the multi-path positions gotten from the multi-path detection, judge whether the multi-path position information in the conjoint frames is changed, if it is changed, output all of the multi-path positions that have been done by the multi-path difference detection, and perform the step B, otherwise, treat the multi-path position gotten from the current frame multi-path detection as the final multi-path detection result, and perform the step C; B, perform multi-path validation with every multi-path position that is output, and perform conjoint multi-path process for the multi-path positions that have been validated, treat the multi-path position processed by the conjoint multi-path process as the final multi-path detection result; C, output the final multi-path detection result. The present invention simultaneously discloses a multi-path searcher, it can guarantee the multi-path searching performance and reduce the occurrence of the false alarm in the dynamic channel efficiently through performing the present invention.

### TECHNOLOGY FIELD

This invention is a multi-path detection technology, in specific, it is a dynamic multi-path detection method and receiver in code division multiple access system (CDMA).

### BACKGROUND TECHNOLOGY

CDMA technology features high capacity, multi-client and soft capacity. It also has the advantage of restraining the noise in the system band. Comparing with the conventional frequency division multiple access (FDMA) and time division multiple access technologies (TDMA), CDMA has obvious advantage. Because of this, the 3^{rd} generation (3G) of mobile communication system, that is based on CDMA technology becomes the mainstream commercial mobile wireless communication system that has been making great progress.

In the wireless communication system that uses CDMA, while being transmitted in the air, on one hand, the wireless signals will be blocked, refracted, reflected and scattered by the barriers and ionospheres, on the other hand, the frequency domain of the band-limited signal may shift and expand. Therefore, the signal received by the receiver is not the direct, one-path signal, actually it is multi-channel signal that comes from different directions and different paths. The original data transmitted in the multi-channel signal are the same, but with different delay. They are the stacking of the copies of the signals that are independent to each other. Normally, we call these signals with same data sources but different paths multi-path signals.

In the direct sequential code division multiple access (DS-CDMA) system, since the data signal is extended by long Pseudorandom (PN) sequences, so each chip lasts very shortly, thus, signals that are transmitted to the receiver through different paths will be effectively separated on the chips. Therefore, if the signals in each channel can be accurately tracked, then treat and integrate the signals in each channel by Rake receiver with multiple receiving fingers, then, the interference caused by the mixing and stacking of multi-path can be converted to gains after integrating through multi-path Rake. Here, the operation of tracking signals in each channel is called multi-path search. Therefore, in order to reduce the interference cause by multi-path mixing and stacking, the main function of the multi-path searching is to detect the most important multi-path vector as accurate as possible, without omitting. The accuracy is to be ½ chip at least.

In the present technology, the structure as shown in FIG. 1 is used to realize the multi-path searcher for the multi-path search, its detailed working principal is: first, the initial searching module 100 receives the data (in frame) which is sent from the receiving filter in the RAKE receiver, then performs relevant power calculation to each sampling point in the scope of searching window; the calculated sample point power will be filtered by the initial filter detection module 102 to delete most sample point noise power on the non multi-path positions. Then send the detected sample power to M frame non-relevant accumulating module 104 and perform non-relevant accumulation to the continuous M-frame sample power; the sample point power, after initial detecting and filtering as well as the non-relevant accumulating, are normally power sample points on the multi-paths and their surroundings, they have been very stable powers. Then send these values to multi-path detecting module 106, then we can obtain the detected multi-paths and their powers. Finally, outputting the result of the multi-path detecting module 106 to the multi-path administrator of the RAKE receiver via the multi-path outputting module 108 for post processing.

At present, there are many different kinds of technology of multi-path searching, however, from a broader view, the performance of the multi-path searching in the CDMA mobile communication system is decided by only two major factors: relevant length of the PN code and data, number of the continuous multi-path search. On one hand, the longer the relevant length is, the greater the processing gain will be, the signal noise ratio (SNR) of the despreading signal will be stronger and the probability of multi-path detection will be higher; on the other hand, the deviation of the receiver's despreading signal under the wireless mobile communication is in direct ratio to the relevant length. This means, with the increase of the relevant length, the increase of the despreading signal SNR will become more and more limited. But for the actual CDMA system receiver, multi-path search is the main consumption of the system resources such as computing volume and electricity consuming. Therefore, the shorter of the multi-path searching relevant length, the better. Thus, in the practical application, normally the relevant length is a fixed value, such as between 1024 chip and 2048 chip.

Once the relevant length is settled, the performance of the multi-path searcher is decided by the number of continuous searching. Theoretical analysis shows: under the certain relevant length, the false alarm and false dismissal of a multi-path searching have a upper limit, which is, the false alarm and false dismissal can not get enough small at the same time, but the multi-path detection result obtained after accumulating many continuous (M-frame) relevant results, can significantly reduce the probabilities of false alarm and false dismissal. Here, one multi-path search normally is one frame, the accumulated relevant results of continuous M-frame is called non-relevant accumulation. Since the multi-path search requires to give accurate result for at least each frame, therefore, the normal solution is, store the relevant results of the continuous M frame, then perform multi-path detection to the accumulated relevant values. The advantage of this solution is, currently, it is still doing the relevance for one frame, only use the relevant results of the continuous M frames via reading the values in the memory, almost no increase to the overall consumption, meanwhile, it can greatly improve the performance of the multi-path search. This method of using multi-frame non-relevant accumulation to improve the multi-path searching performance is widely used in current technologies.

Although, the M-frame non-relevant accumulation processing can effectively improve the performance of the multi-path search, but to certain circumstances, it still has worrying potentials. Due to the complicity of the modern wireless communication, dynamic signal channel always exists, such as birth-death signal channel and mobile signal channel. In this case, main multi-paths will shift or disappear at different time, and new multi-paths will appear on the new positions. If a certain multi-path exists as a strong power in the previous M−1 frame, and it shifts or disappears in the time of the current frame, then, by using the method of M-frame non-relevant accumulating, output the multi-path that does not exist in the current frame as a valid path. It is because of using continuous M-frame for non-relevant accumulating process, this outputting error will occur up to M−1 times. Once false alarm occurs, it will have significant impact on the performance of the entire system; on the other hand, after the wrong multi-path is assigned to the finger of the RAKE receiver, the finger will have to do a lot of useless work, wasting a great quantity of system resources; on the other hand, since the wrong multi-path takes the correspondent finger, the correct multi-path will not be assigned timely. Thus, the SNR of the integrated signal will drop dramatically, causing the system to deteriorating.

Therefore, how to achieve greater performance for the multi-path searching at a comparably smaller cost, meanwhile, to significantly avoid the occurrence of the false alarm in the dynamic channel, is an important issue in the multi-path searching.

### CONTENT OF THE INVENTION

Due to abovementioned reason, this invention is mainly to provide a dynamic multi-path detection method in the CDMA system. It can reduce the burden of the multi-path tracking, meanwhile, effectively reduce the probabilities of false alarm under the dynamic signal channel.

The other purpose of this invention is to provide a multi-path searcher that can effectively reduce the probabilities of false alarm in the signal channel.

In order to achieve the above purpose, the technical solution of this invention is achieved by:

A dynamic multi-path detection method in the CDMA system, the method includes:

A. Performing dynamic multi-path difference detection to the multi-paths obtained from the multi-path detection, judging if the multi-path position information in the conjoint frames have been changes, if yes, then outputting all the multi-path positions that have been done by the multi-path difference detection, going to step C, otherwise, treating the multi-path position obtained from the multi-path detection in the current frame as the final result of the multi-path detection, going to step C;
B. Performing multi-path detection to each outputted multi-path position, and performing conjoint multi-path process to the verified multi-path positions, treating the multi-path positions that have been done by multi-path processing as the final result of the multi-path detection;
C. Outputting the final result of the multi-path detection.

In which, step A includes:

A1. Separately storing the multi-path positions of the strongest L path in the current and previous frames; storing the multi-path positions in the forgoing frame and previous frame as well as the finally outputted multi-path positions in the form of array;
A2. Comparing to see if the two are identical, if not, then storing all the detected multi-path positions without repeating, and setting multi-path change marks; if yes, then storing the detected multi-path of the current frame and repeating the marks for the multi-path changes.
A3. Outputting the final multi-path positions and storing the result and value of the multi-path change marks.

In the above-mentioned solution, in step B, the detailed process of the multi-path verifying to a multi-path position includes:

B11. Receiving the to-be-verified multi-path positions, calculating the multi-path power at the forgoing multi-path positions, and calculating the noise power at the forgoing multi-path position plus dis_win; in which, dis-win is a length value that is greater than the multi-path delay window;
B12. Calculating the difference between the forgoing multi-path power and the forgoing noise power, treating it as the denoising multi-path power;
B13. Judging if the denoising multi-path power is greater than the product of the power detection threshold and the forgoing noise power, if yes, the treating the current verified multi-path position as the valid multi-path position, if not, ending the current process.

In which, the multi-path processing described in step B further includes:

B21. Sorting the verified multi-path positions pos[i] and the corresponding power pwr[i] in the sequential order of delay, in which, i=1 . . . 2L, L is the number of finger of the RAKE receiver;
B22. Judging if the difference between pos[i+1] and pos[i] is less than dN, if yes, then going to step B23; otherwise, going to B29; in which, dN is N/2, N represents the number of the sampling delay point corresponding to a chip;
B23. Judging the difference between pos[i+2] and pos[i+1] is less than dN, if yes, then going to step 24; otherwise, going to step B28;
B24. Judging if (pwr[i]+pwr[i+2])/2<T0*pwr[i+1], if yes, then going to step B26; otherwise, going to step B25;
B25. Judging if (pwr[i]+pwr[i+2])/2<T1*pwr[i+1], if yes, then going to step B27; otherwise, going to step B26;
B26. After setting power pwr[i], pwr[i+2] as 0, then going to step B28;
B27. Setting pwr[i+1] as 0;
B28. Judging if pwr[i+1] is greater than pwr[i], if yes, then setting pwr[i] as 0; otherwise, setting pwr[i+1] as 0;
B29. At pwr[i]>0, outputting pwr[i] and the corresponding pos[i].

The invention also provides a multi-path searcher, including initial searching module, initial filter detecting module, M-frame irrelevant accumulating module, multi-path detecting module and multi-path outputting module, its character is, between the multi-path detecting module and the multi-path outputting, the multi-path searcher also includes dynamic multi-path processing module that is used to perform dynamic multi-path detection to the multi-path positions that have been done by the multi-path detection. This is to determine if the signal channel has been changed, if yes, then performing multi-path verification and conjoint multi-path process to the multi-path positions that have been done by the dynamic multi-path detection.

In which, the forgoing dynamic multi-path processing module further includes:

Dynamic multi-path difference detection module that is used to receive the multi-path positions outputted by the multi-path detection module, perform signal channel difference detection and output the processed multi-path positions and control variables to the output selecting module; output selecting module that is used to determine if the signal channel has been changed based on the received multi-path positions and control variables as well as output the selected result to the multi-path verifying module or the forgoing multi-path outputting module; multi-path verifying module that is used to verify the validity of each multi-path position that is sent from the outputting selecting module, and output the detected multi-path positions to the conjoint multi-path processing module; conjoint multi-path processing module, it is used to process the conjoint multi-path and out put the processed, valid multi-path position to the multi-path outputting module.

The forgoing dynamic multi-path different detecting module further includes:

storing unit that is used to store the multi-path positions of the strongest L path that have been done by multi-path detection in the current and previous frames, store the final output result of the forgoing dynamic multi-path difference detection module and set the mark for the change of the multi-path; comparing unit that is used to compare the multi-path of the strongest L path in the stored current frame and previous frame and to determine if the multi-path has been changed; outputting Unit, it is used to output the final output result stored in the storing unit.

In the above-mentioned solution, the forgoing multi-path verifying module further includes:

receiving unit that is used to receive the to-be-verified multi-path position pos[i];
calculating multi-path power unit that is used to calculate the multi-path power and the denoising multi-path power of pos[i]; judging and comparing unit that is used to judge if the multi-path position is valid, and if all the to-be-verified multi-path positions have been verified; information outputting unit that is used to output all valid multi-path positions and the corresponding denoising multi-path power.

The forgoing conjoint processing module further includes: sorting unit that is used to sort the multi-path positions and the corresponding power in the sequential order of delay;

conjoint multi-path detecting unit that is used to detect the peak of the real path in the conjoint multi-path and set the power of the non-real path as 0; single multi-path determining unit that is used to select and keep one multi-path in ½ chip in the conjoint multi-path positions; delay information processing unit, it is used to buffer and output all greater-than-0 powers and the corresponding multi-path positions that have been done by the conjoint multi-path detection.

This invention provides a dynamic multi-path detection method in the CDMA system and its device. It is an optimal solution addresses the issues of multi-path changes under the conditions of dynamic signal channel such as birth-death and shifting to which the present technology is unable to solve. The detection occurs only when the strongest L path is detected, therefore, while no changes on the multi-path, there will be no consumption to the system. However, while changes occur on the multi-path, it can guarantee the accuracy of the multi-path by very few computing volume, thus avoid the useless waste of the system, meanwhile, effectively prevent from losing the system performance, therefore, significantly improve the entire performance of the system.

In this invention, if the signal channel changes, accurate detection of the dynamic multi-path can be achieved with very little computing volume. Also, the conjoint processing sector in this invention can correct the majority of errors occurred in the multi-path technology in the current technology. Therefore, the invention is featured with good practicability, low complicity and obvious improvement to the system.

The invention also presents a method to verify the changed multi-path and to process the conjoint multi-path, making the multi-path optimized and enhanced.

### BRIEF DESCRIPTION OF THE DRAWINGS

FIG. 1 is the structural sketch of the composition of the multi-path searcher in current technology;

FIG. 2 is the sketch of the process of the dynamic multi-path detection method in this invention;

FIG. 3 is the sketch of the principal of the dynamic multi-path difference detection in this invention;

FIG. 4 is the sketch of the process of the changed multi-path verification in this invention;

FIG. 5 is the sketch of the process of the conjoint multi-path processing in this invention;

FIG. 6 is the structural sketch of the composition of the receiver in the CDMA system;

FIG. 7 is the structural sketch of the composition of the multi-path searcher in this invention

### DETAILED DESCRIPTION OF THE PREFERRED EMBODIMENT

The principal of this invention is: for the outputted multi-path position information that has been done by the multi-path detection, through comparing the multi-path detection results in conjoint frames to further see if they are identical, so that to make sure if the signal channels have changes; if the signal channel changed, after performing multi-path verifying and conjoint multi-path processing to the multi-paths outputted from the multi-path detection, outputting them as the multi-path positions of the multi-path detection, then finish the post-processing.

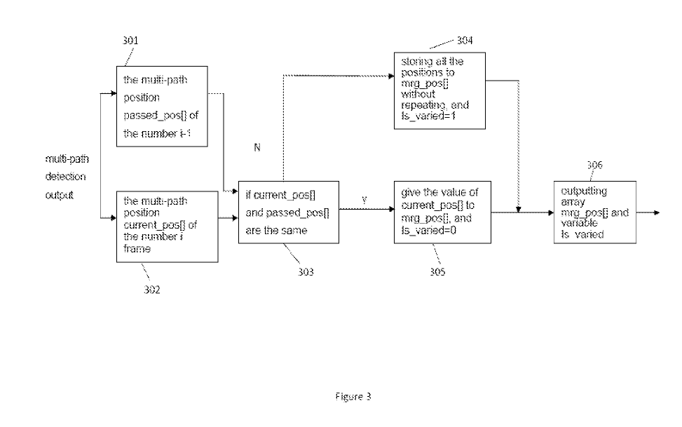

The dynamic multi-path detection method in this invention is shown as FIG. 2, including following steps:

Step 201-202: performing dynamic multi-path difference detection to the multi-path positions obtained from the multi-path detection, comparing the multi-path position information in the two conjoint frames, judging if the multi-path position information has changes, if yes, then outputting all the multi-path positions from the multi-path difference detection as the to-be-verified multi-path positions, going to step 203; otherwise, treating the multi-path position from the multi-path detection in the current frame as the final result of the multi-path detection, going to step 205. In this case, the forgoing dynamic multi-path detection is actually to compare every two conjoint frames in order and then judge. The detailed operation to every two conjoint frames is: separately storing the multi-path detection results for the current and previous frames, that is the multi-path position of the strongest L path in each frame, then, comparing to see if the two are the same, if not, that means change has occurred, then storing all the detected multi-path positions without repeating, and setting the multi-path change mark, if yes, that means no change has occurred, then storing the multi-position of the current frame, that is, to treat the multi-path position of the strongest L path as the multi-path detection result, and resetting the multi-path change mark; finally, outputting the final result of the stored multi-path position and the value of the multi-path change mark. In which, L is a fixed continuous, it's value can be the number of the multi-path finger of the RAKE receiver.

Step 203: performing multi-path verification to each outputted to-be-verified multi-path position.

Step 204: performing conjoint multi-path processing to the verified multi-path positions, and treating the multi-path positions that have been processed by conjoint multi-path treatment as the final multi-path detection result.

Step 205: Outputting the final multi-path detection result.

Before implementing the method in this invention, two steps normally need to be carried out first in order to obtain the multi-path position of the multi-path detection.

Step a: Performing initial search and initial filtering detection to the multi-path signal. The detailed operation is: for the data that is received from the RAKE receiver and is in frame, calculating the relevant power to each sampling point that in the scope of the searching window; filtering away the majority of the calculated sample point power, that is the sample point noise power on the non multi-path positions.

Step b: performing non-relevant accumulation and multi-path detection to the sample point power from the filtering detection. The detailed operation is: performing non-relevant accumulation to the sample point power for continuous M-frame from the filtering detection, then performing multi-path detection to the sample point power that have been done by the non-relevant accumulation, obtaining the multi-path positions and their power that have been done by the multi-path detection.

In the process shown in FIG. 2, step 201 and step 202 may use the form of array to store and keep the multi-path positions and setting a variable as the multi-path change mark, achieving setting and resetting of the multi-path change marks by setting 0 or 1. The detailed procees of the dynamic multi-path difference detection is shown in FIG. 3. In FIG. 3, we use the array of current_pos[ ] to store the multi-path detection result of the current frame, passed_pos[ ] to store the mult-path detection result of the previous frame, array of mrg_pos[ ] to store the final multi-path positions and variable Is_varied as the multi-path change mark, including following steps:

Step 301-302: separately storing the multi-path position of the strongest L path outputted from the multi-path detection in the current frame to the array current_pos[ ], and storing the multi-path position of the strongest L path outputted from the multi-path detection in the previous frame to the array passed_pos[ ]. In this invention, multi-path positions are continuously outputted using one frame as a measurement.

Step 303: comparing to see if the array of current_pos[ ] and passed_pos are the same, if yes, then going to step 305; otherwise, going to step 304.

Step 304: storing all the multi-path positions appeared in current_pos[ ] and passed_pos[ ] to array mrg_pos[ ] without repeating, then setting Is_varied as 1, going to step 306.

Step 305: giving the value of array current_pos[ ] to array mrg_pos[ ], and setting Is_varied as 0.

Step 306: outputting array mrg_pos[ ] and the value of variable Is_varied. In which, mrg_pos[ ] is treated as the to-be-verified multi-path information or the final multi-path detection result, Is_varied is treated as the control signal.

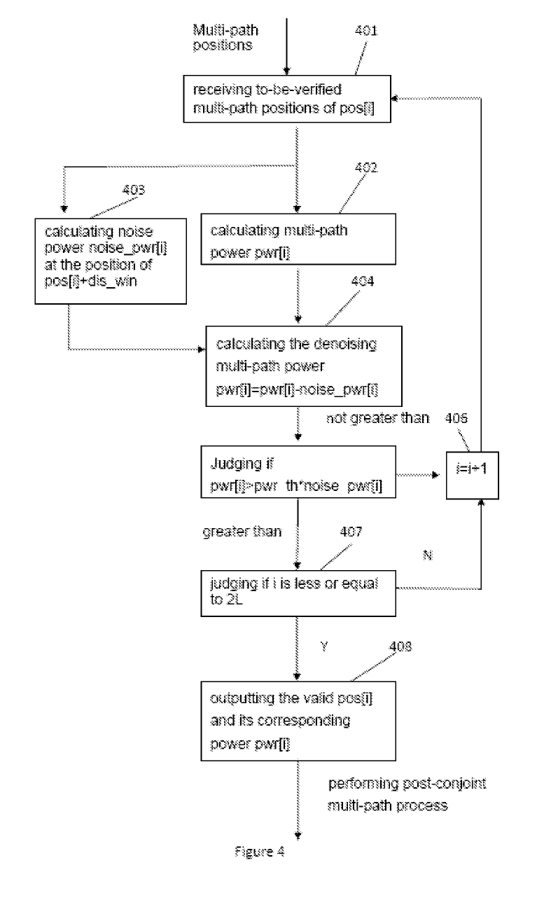

In the process shown in FIG. 2, the multi-path detection method describe in step 203 is shown in FIG. 4, the details include following steps:

Step 401: receiving the to-be-verified multi-path position pos[i], in which I is a pointer variable, i=1, 2L, L is the number of the finger in the RAKE receiver. In here, the multi-path position in pos[ ] is the multi-path position finally outputted in step 306 in FIG. 3.

Step 402-403: Calculating the multi-path power pwr[i] at the multi-path position pos[i], and calculating the noise power moise_pwr[i] at (pos[i]+dis_win).

In which, normally dis_win is a length value that is greater than the multi-path delay window, for example: in the FDD system of 3GPP, supposing the maximum delay is extended to 20 ms, then the corresponding delay is 80 chips, then, under the N-times oversampling, dis_win can take a value outside the scope that is greater than 80*N or less than −80*N, for example ±100*N. In this step, calculating the noise power at (pos[i]+dis_win) is to determine a reference noise power in order to determine the validity of the multi-path position.

Step 404: calculating the denoising multi-path power pwr[i]=pwr[i]-noise_pwr[i].

Step 405-406: judging if the denoising multi-path power pwr[i] is greater than the product of pwr_th and noise_pwr[i], that is to determine the validity of this multi-path position, if yes, then treating the currently verified multi-path position as the valid multi-path position, going to step 407; otherwise, adding 1 to i, returning to step 401.

Here, pwr_th is the preset power detection threshold, pwr_th take value in the scope of [4, 100].

Step 407: Judging if the verification is ending, that is to judge if i≦2L, if yes, then going to step 408, otherwise, adding 1 to i, returning to step 401.

Step 408: Outputting all valid multi-path position pos[i] and the corresponding denoising multi-path power pwr[i].

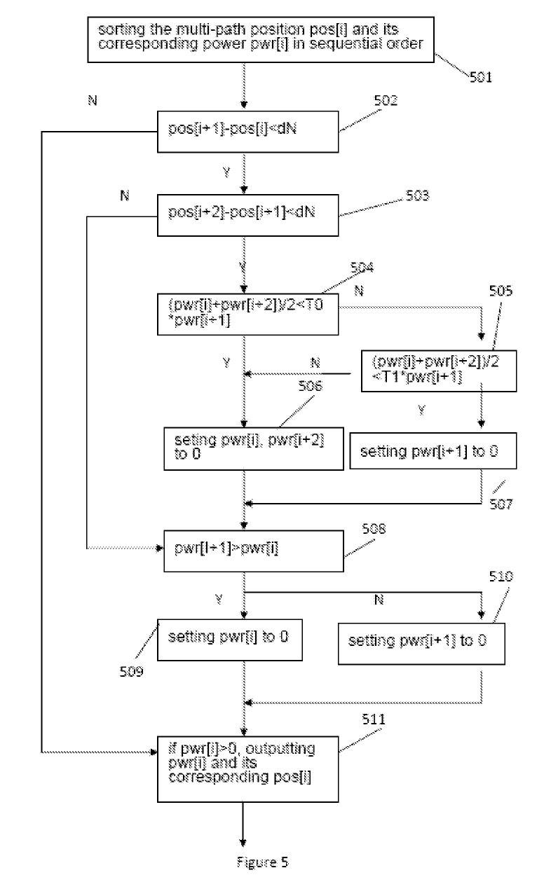

In the process shown in FIG. 2, the conjoint multi-path processing method described in step 204 is shown in FIG. 5, the details include following steps:

Step 501: sorting the verified multi-path position pos[i] and the corresponding power pwr[i] in sequential order.

Step 502: judging if the difference between pos[i+1] and pos[i] is less than dN, if yes, then going to step 503, otherwise, going to step 511.

In which, dN is N/2, N represents the number of the sampling point that corresponding to a chip. The judgment in step 502 is to select and keep one multi-path in ½ chip.

Step 503: judging if the difference between pos[i+2] and pos[i+1] is less than dN, if yes, then going to step 504; otherwise, going to step 508.

Step 504: Judging if (pwr[i]+pwr[i+2])/2<T0*pwr[i+1], if yes, then going to step 506, otherwise, going to step 505.

Step 505: Judging if (pwr[i]+pwr[i+2])/2<T1*pwr[i+1], if yes, then going to step 507, otherwise, going to step 506.

Step 506: setting power pwr[i], pwr[i+2] as 0, then going to step 508.

Step 507: setting pwr[i+1] as 0.

Step 508-510: judging if pwr[I+1] is greater than pwr[i], if yes, then setting pwr[i] as 0; otherwise, setting pwr[i+1] as 0.

Step 511: if pwr[i]>0, then outputting the pwr[i] and its corresponding pos[i].

The conjoint multi-path processing in this invention adopts the short delay peak detection method presented in another patent application. The method can delete the impact of conjoint multi-path stacking and detect the peak of the real path. In which, T0 and T1 are respectively two conjoint detecting threshold, normally, T0 is within [0.40, 0.49] and T1 is within [0.49, 0.82].

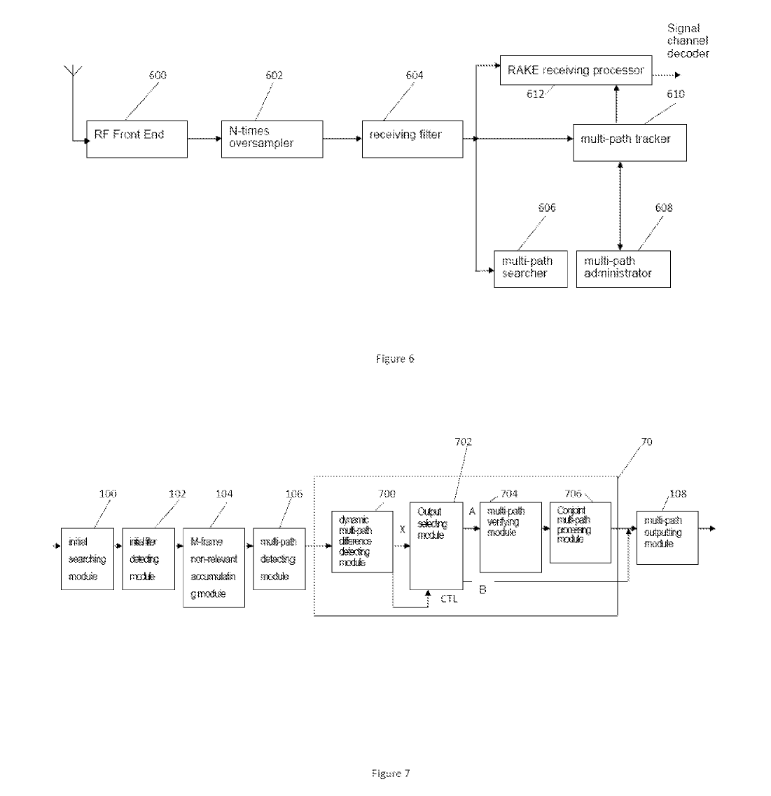

The structure of the CDMA receiver that the dynamic multi-path detection relies on is shown as FIG. 6, including: RF Front End 600, N-times oversampler 602, receiving filer 604, multi-path searcher 606, multi-path tracker 610, multi-path administer 608 and RAKE receiver 612. In which, the RF Front End 600 is used to finish the processing of the receiving FR, that is: to finish data's conversion from electro-magnetic signal to baseband signal. The processed signal, through N times oversampler 602, is sent to receiving filter 604. The N-times oversampler 602 is used to realize the N-times oversampling of the baseband signal, in which, N should not be less than 2.

The receiving filter 604 is used to finish the receiving, matching and filtering of the signal after oversampled by the N-times oversampler 602. If the sending end uses root-raised cosine (RRC) filter, then RRC filter should also be used on the receiving end. The filtered signal has the same effect as the sending signal that is filtered by RRC. The multi-path searcher 606 is used to roughly search the delay position of each multi-path signal, and send the found multi-path delay position to the multi-path administrator, normally the accuracy is not lower than ½ chip. The multi-path administrator 608 is used to administer, coordinate and distribute the found multi-path delay information and provide the multi-path delay position to the multi-path tracker 610. The multi-path tracker 610 is used to track the multi-path delay position provided by multi-path administer 608 and perform fine synchronization. It provides the various tracked accurate multi-path delay position information to RAKE receiving processor 612 and feed back to multi-path administer 608. Normally its accuracy is not lower than ⅛ chip. The RAKE receiving processor 612 is used to realize the demodulation and integration of data.

The signal that is oversampled by N-times oversampler 602, after being matched and filtered in the receiving filter 604, is divided into 3 paths: one path is processed in multi-path searcher 606, multi-path administrator 608, obtaining rough multi-path position information; one path is under the control of the multi-path administrator 608, processed by multi-path tracker 610, obtaining the accurate value of each path delay information, in this case, the baseband data in the same path is sent to multi-path searcher 606 and the multi-path tracker 610 as the input data; the other path is to send the data that is processed by the receiving filter 604 to RAKE receiving processor 12, and finish the demodulation of the baseband data under the control of the delay information outputted by the multi-path tracker 610. Date that is demodulated by RAKE receiving processor 612 is finally sent to the channel decoder for decoding to recover the sent data.

From the dynamic multi-path detection method described in FIG. 2 to FIG. 5, we learn that, in this invention, the key part to realize the dynamic multi-path detection is the multi-path searching. To realize the multi-path searching in this invention, this invention provides a multi-path searcher, its composition structure is shown as FIG. 7, including initial searching module 100, initial filter detecting module 102, M-frame non-relevant accumulating module 104, multi-path detecting module 106 and multi-path outputting module 108. Between the multi-path detecting module 106 and the multi-path outputting module 108, the multi-path searcher also includes dynamic multi-path processing module 70 that is used to perform dynamic multi-path detection to the multi-path positions obtained from the multi-path detection, in order to determine if the signal channel has changed, also, in case that the signal channel has changed, performing multi-path detecting and conjoint multi-path processing to the multi-path positions obtained from the dynamic multi-path detection.

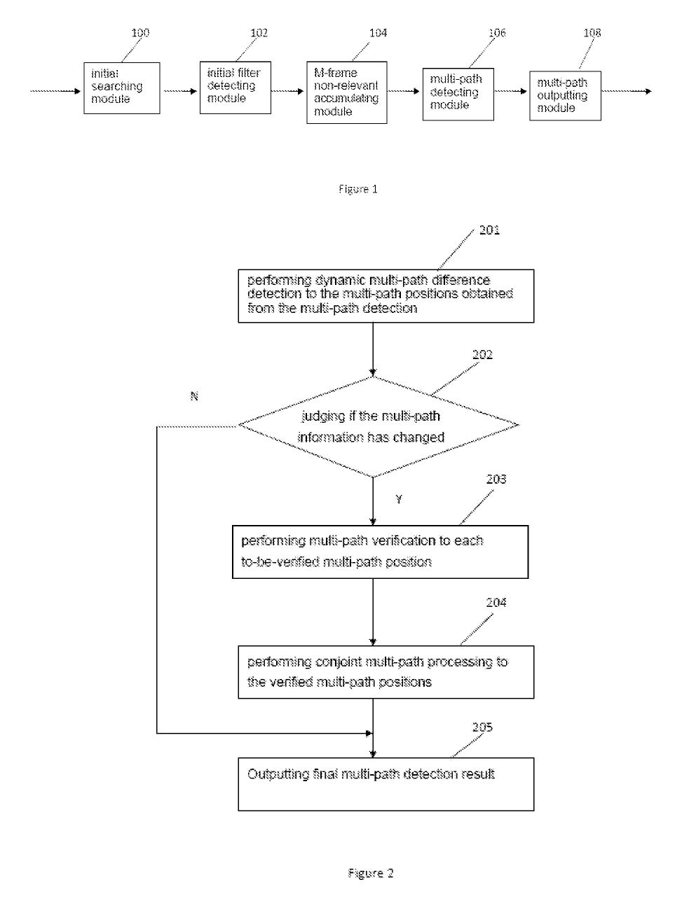

The forgoing multi-path processing module further includes: multi-path difference detecting module 700, output selecting module 702, multi-path verifying module 704 and conjoint multi-path processing module 706.

In which, dynamic multi-path difference detecting module 700 receives the multi-path positions obtained by multi-path detection from the multi-path detecting module 106, performing signal channel difference detection, then outputting the processed multi-path positions to the X port of the output selecting module 702, outputting control variable to the CTL port of output selecting module 702. The output selecting module 702, based on multi-path positions and control variables, determines if the signal channel has changes, and output the selecting result via its a port or B port. Normally, the real value of the input and output ports of the output selecting module 702 is shown as FIG. 1:

| Input | CTL | A | B |
|---|---|---|---|
| X | 0 | — | X |
| X | 1 | X | — |

In figure, 1, “—” means no output.

If the dynamic multi-path difference detecting module 700 determines there is no change on the signal channel, then, the value that is outputted to the CTL port of the output selecting module 702 is 0. The multi-path generated by multi-path detecting module is directly outputted from the B port of the outputting selecting module 702 to the multi-path outputting module 108. Here, the function of the multi-path outputting module is exactly the same as the one in the current technology. While the dynamic multi-path difference detecting module 700 determines there is change on the dynamic multi-paths, then the dynamic multi-path difference detecting module 700 will integrate the multi-path positions of the continuous two frame—before and after the change, then outputting to the X port of the output selecting module 702, meanwhile, sending control signal 1 to the CTL port of the output selecting module 702. Thus, the multi-path positions integrated in the dynamic multi-path difference detecting module 700, after being selected by the output selecting module 702, is sent to the multi-path verifying module 704 via the A port. The multi-path verifying module 704 performs validity verification to the multi-path position sent from module 702, then output the multi-path positions that have been done by multi-path verification to the conjoint multi-path processing module 706. After verifying by the multi-path verifying module, more than one valid multi-path positions may appear in one chip, therefore, the conjoint multi-path processing module 706 needs to process the conjoint multi-path positions. The valid multi-path positions after being processed by conjoint multi-path processing module 706 is outputted to the multi-path administrator 608 via multi-path outputting module 108.

In the forgoing dynamic multi-path processing module 70, the forgoing dynamic multi-path difference detecting module 700, in terms of its logic function, further includes: storing unit, comparing unit and outputting unit, in which, the storing unit is used to store the multi-path positions of the strangest L path that is being multi-path detected of the current and previous frames. It is used to store the final result of the dynamic multi-path difference detecting module 700 and set the multi-path change marks; the comparing unit is used to compare the stored multi-path positions of the strangest L path in the current and previous frames in order to determine if the multi-path has changed; the outputting unit is used to output the final outputting result stored in the storing unit.

The forgoing multi-path verifying module 704, in terms of its logic function, further includes: receiving unit, multi-path power calculating unit, judging and comparing unit, information outputting unit, in which, the receiving unit is used for the to-be-verified multi-path positions pos[i]; the multi-path power calculating unit is used to calculate the multi-path power of pos[i] and its denoising multi-path power; judging and comparing unit is used to judge the validity of the multi-path positions as well as if all the to-be-verified multi-path positions have been verified; information outputting unit is used to output all the valid multi-path positions and their corresponding denoising multi-path power.

The forgoing multi-path processing module 706, in terms of its logic function, further includes: sorting unit, single multi-path determining unit, conjoint multi-path detecting unit, delay information processing unit. In which, the sorting unit is used to sort the multi-path positions obtained from the multi-path verification and the corresponding power in the sequential order; the conjoint multi-path detecting unit is used to detect the peak of the real path and set the power of the non real path to 0; the single multi-path determining unit is used to select and keep one multi-path in ½ chip in the conjoint multi-path positions; the delay information processing unit is used to buffer and output all the power that is greater than 0 and its corresponding multi-path positions that are obtained from the conjoint multi-path detection.

The above-mentioned is only the preferred embodiment of this invention. It is not used to limit the protected scope of this invention.

1. It is a dynamic multi-path detecting method in CDMA communication system, the method includes:
A. Performing dynamic multi-path difference detection to the multi-path positions obtained from multi-path detection, judging if the multi-path information in the conjoint frames is changed, if yes, then outputting all the multi-path positions that have been done by the multi-path difference detection, going to step B, otherwise, treating the multi-path positions that have been done by the multi-path detection in the current frame as the final multi-path detection result, going to step C;
B. Performing multi-path verification to the multi-path position of each output, and performing conjoint multi-path processing to the multi-path positions that have been verified, treating the multi-path positions that have been done by the conjoint multi-path processing as the final multi-path detection result;
C. Outputting final multi-path detection result.

2. According to claim 1 of the forgoing dynamic multi-path detection method, its character is,
A1. Separately storing the multi-path positions of the strongest L path in current frame and previous frame;
A2. Comparing the two and see if they are identical, if yes, then storing all detected multi-path positions without repeating, and setting marks for the changes of the multi-path; if not, then storing the detected multi-path positions in the current frame, and resetting the marks for the changes of the multi-path;
A3. Outputting final multi-path positions and storing results and marks for the changes of multi-path,

3. According to claim 2 of the forgoing dynamic multi-path detection method, its character is: the multi-path positions in the forgoing current frame and previous frame and the outputted final multi-path positions are stored in the form of array.

4. According to any description of claims 1-3 of the forgoing dynamic multi-path detection method, its character is: in step B, the detailed process of the verification to a multi-path position includes:
B11. Receiving the to-be-verified multi-path positions, calculating the multi-path power at the forgoing multi-path positions, and calculating the noise power at the forgoing multi-path position plus dis_win; in which, dis_win is a length value that is greater than the multi-path delay window;
B12. Calculating the difference between the forgoing multi-path power and the forgoing noise power, treating it as the denoising multi-path power;
B13. Judging if the denoising multi-path power is greater than the product of the power detection threshold and the forgoing noise power, if yes, the treating the current verified multi-path position as the valid multi-path position, if not, ending the current process.

5. According to claim 4 of the forgoing dynamic multi-path detection method, its character is: the forgoing multi-path verification further includes: performing step B11-B13 to each to-be-verified multi-path, then, outputting all the valid multi-path positions and their corresponding denoising multipath power.

6. According to claim 5 of the forgoing dynamic multi-path detection method, its character is: the conjoint multi-path process described in step B further includes:
B21. sorting the verified multi-path positions pos[i] and the correspondent power pwr[i] in the sequential order of delay, in which, i=1 . . . 2L, L is the number of finger of the RAKE receiver;
B22. Judging if the difference between pos[i+1] and pos[i] is lea than dN, if yes, then going to step B23; otherwise, going to step B29; in which, dN is N/2, N represents a chip corresponding number of the sampling delay points
B23. Judging if the difference of pos[i+2] and pos[i+1] is less than dN, if yes, then going to step B24; otherwise, going to step B28;
B24. Judging if (pwr[i]+pwr[I+2])/2<T0*pwr[i+1], if yes, then going to step B26, otherwise, going to step B25;
B25. Judging if (pwr[i]+pwr[i+1])/2>T1*pwr[i+1], if yes, then going to step B27; otherwise, then going to step B26;
B26. Setting power pwr[i], pwr[i+2] as 0, then going to step B28;
B27. setting pwr[i+1] as 0;
B28. Judging if pwr [i+1] is greater than pwr[i], if yes, then setting pwr[i] as 0, otherwise, setting pwr[i+1] as 0;
B29. At pwr[i]>0, outputting pwr[i] and the corresponding pos[i].

7. According to any description of claim 1-3 of the forgoing dynamic multi-path detection method, its character is: the conjoint multi-path process described in step B further includes:
B21. Sorting the verified multi-path positions pos[i] and the corresponding power pwr[i] in the sequential order of delay, in which, i=1 . . . 2L, L is the number of finger of the RAKE receiver;
B22. Judging if the difference between pos[i+1] and pos[i] is less than dN, if yes, then going to step B23; otherwise, going to B29; in which, dN is N/2, N represents the number of the sampling delay point corresponding to a chip;
B23. Judging the difference between pos[i+2] and pos[i+1] is less than dN, if yes, then going to step 24; otherwise, going to step B28;
B24. Judging if (pwr[i]+pwr[i+2])/2<T0*pwr[i+1], if yes, then going to step B26; otherwise, going to step B25;
B25. Judging if (pwr[i]+pwr[i+2])/2<T1*pwr[i+1], if yes, then going to step B27; otherwise, going to step B26;
B26. After setting power pwr[i], pwr[i+2] as 0, then going to step B28;
B27. Setting pwr[i+1] as 0;
B28. Judging if pwr[i+1] is greater than pwr[i], if yes, then setting pwr[i] as 0; otherwise, setting pwr[i+1] as 0;
B29. At pwr[i]>0, outputting pwr[i] and the corresponding pos[i].

8. It is a multi-path searcher, including initial searching module, initial filter detecting module, M-frame irrelevant accumulating module, multi-path detecting module and multi-path outputting module, its character is, between the multi-path detecting module and the multi-path outputting, the multi-path searcher also includes dynamic multi-path processing module that is used to perform dynamic multi-path detection to the multi-path positions that have been done by the multi-path detection. This is to determine if the signal channel has been changed, if yes, then performing multi-path verification and conjoint multi-path process to the multi-path positions that have been done by the dynamic multi-path detection.

9. According to claim 8 of the forgoing dynamic multi-path detection method, its character is: the forgoing dynamic multi-path processing module further includes:
Dynamic multi-path difference detection module, it is used to receive the multi-path positions outputted by the multi-path detection module, perform signal channel difference detection and output the processed multi-path positions and control variables to the output selecting module;
Output selecting module, it is used to determine if the signal channel has been changed based on the received multi-path positions and control variables, output the selected result to the multi-path verifying module or the forgoing multi-path outputting module;
Multi-path verifying module, it is used to verify the validity of each multi-path position that is sent from the outputting selecting module, and output the detected multi-path positions to the conjoint multi-path processing module;
Conjoint multi-path processing module, it is used to process the conjoint multi-path and out put the processed, valid multi-path position to the multi-path outputting module.

10. According to claim 9 of the forgoing multi-path searcher, its character is: the forgoing dynamic multi-path different detecting module further includes:
Storing Unit, it used to store the multi-path positions of the strongest L path that have been done by multi-path detection in the current and previous frames, store the final output result of the forgoing dynamic multi-path difference detection module and set the mark for the change of the multi-path;
Comparing unit, it is used to compare the multi-path of the strongest L path in the stored current frame and previous frame and to determine if the multi-path has been changed;
Outputting Unit, it is used to output the final output result stored in the storing unit.

11. According to claim 9 or 10 of the forgoing multi-path searcher, its character is: the forgoing multi-path verifying module further includes:
Receiving unit, it is used to receive the to-be-verified multi-path position pos[i];
Calculating multi-path power unit, it is used to calculate the multi-path power and the denoising multi-path power of pos[i];
Judging and comparing unit, it is used to judge if the multi-path position is valid, and if all the to-be-verified multi-path positions have been verified;
Information outputting unit, it is used to output all valid multi-path positions and the corresponding denoising multi-path power.

12. According to claim 9 or 10 of the forgoing multi-path searcher, its character is: the forgoing conjoint processing module further includes:
Sorting unit, it is used to sort the multi-path positions and the corresponding power in the sequential order of delay;
Conjoint multi-path detecting unit, it is used to detect the peak of the real path in the conjoint multi-path and set the power of the non-real path as 0;
Single multi-path determining unit, it is used to select and keep one multi-path in ½ chip in the conjoint multi-path positions;
Delay information processing unit, it is used to buffer and output all greater-than-0 powers and the corresponding multi-path positions that have been done by the conjoint multi-path detection.
